(19) United States
(12) Patent Application Publication
(10) Pub. No.: US 2017/0086493 A1
(43) Pub. Date: Mar. 30, 2017

(54) Bordering image in liquid printing process

(71) Applicants: Hue P. Le, Beaverton, OR (US); Tai Ngoc Dang, Portland, OR (US); Tue Nguyen, Fremont, CA (US)

(72) Inventors: Hue P. Le, Beaverton, OR (US); Tai Ngoc Dang, Portland, OR (US); Tue Nguyen, Fremont, CA (US)

(21) Appl. No.: 15/044,100

(22) Filed: Feb. 15, 2016

Related U.S. Application Data
(63) Continuation-in-part of application No. 14/867,005, filed on Sep. 28, 2015.

(51) Int. Cl. A23P 20/15; B41J 2/21

(52) U.S. Cl. CPC A23P 20/15; B41J 2/21; A23P 2020/253

(57) ABSTRACT

Ink jet printing on a liquid medium can be performed using liquid inks having a thermo inversion gelling property. A barrier can be formed surrounding the printed image to minimize diffusion of the image border gel droplets. The barrier can include an image border printed in clear color ink.

The present application is a continuation-in-part of application serial number Ser. No. 14/867,005, filed on Sep. 28, 2015, entitle: “Printing on liquid medium using liquid ink”, which is hereby incorporated by reference in its entirety.

### BACKGROUND

Automated printers using edible inks have been developed for printing on food products, e.g., printing directly on the food products, or separately printing on a sheet and placing it on the food products. The printing process typically uses liquid ink on solid or semi-solid surface, e.g., non-liquid substrate, for example, a foam top surface of a liquid beverage, such as a foam milk portion of a coffee drink.

Direct printing of liquid ink on liquid surface can represent difficulty, for example, since the liquid ink can disperse rapidly upon reaching the liquid substrate, distorting the printed image. For example, an inherent problem associated with aqueous inks employed in liquid printing, e.g., printing a liquid ink on a liquid medium, is the dispersion of ink drops after placement onto the liquid substrate. Dispersing can cause intercolor bleeding, poor resolution, and image degradation adversely affecting the print quality.

Thus there is a need for printing of liquid ink on a liquid substrate with minimal dispersion.

### SUMMARY

In some embodiments, the present invention discloses methods and systems for printing an image together with image border elements on a liquid. The methods can use a liquid ink that gels when contacting the liquid. The printed border elements can prevent or reduce the gel dots at the edges of the image from being dispersed, allowing the formation of a high resolution image on the liquid.

### BRIEF DESCRIPTION OF THE DRAWINGS

FIGS. 1A-1C illustrate a printing process using a liquid ink on a liquid substrate according to some embodiments.

FIGS. 2A-2D illustrate border printing processes according to some embodiments.

FIGS. 3A-3F illustrate a process for printing an image on a liquid medium according to some embodiments.

FIGS. 4A-4C illustrate flow charts for liquid printing according to some embodiments.

FIG. 5 illustrates a flow chart for liquid printing according to some embodiments.

FIGS. 6A-6B illustrate a print head having a clear color printing assembly according to some embodiments.

FIG. 7 illustrates a schematic of a printer for printing on a liquid according to some embodiments.

### DETAILED DESCRIPTION OF THE EMBODIMENTS

In some embodiments, the present invention discloses methods and systems for automated printing on liquid substrates, such as liquid beverages, using liquid ink, such as edible liquid ink.

The liquid ink can include a thermogelling component, which can cause the liquid ink to gel when experiencing a different temperature than the temperature of the liquid ink. For example, the liquid ink can include a hyperthermogelling component, which can cause the liquid ink to gel at temperatures higher than a gelling temperature of the liquid ink. For example, the liquid ink can be a liquid at room temperature, e.g., 25 C., and can have a gelling temperature of 50 C., e.g., the liquid ink can gel at temperatures above 50 C. The liquid ink can be ink jet printed on a hot liquid with the temperature of the liquid greater than the gelling temperature of the liquid ink, for example, higher than 50 C. Upon contacting the hot surface, the liquid ink can gel, e.g., the viscosity of the liquid ink can change significantly from a liquid-like ink to a gel-like ink.

Alternatively, the liquid ink can include a different thermogelling component, which can cause the liquid ink to gel at temperatures lower than the temperature of the liquid ink. For example, the liquid ink can be a liquid at room temperature, e.g., 25 C., and can gel at temperatures below 25 C. The liquid ink can be ink jet printed on a cold or cool liquid, e.g., having temperature lower than, for example, 25 C. Upon contacting the cold or cool surface, the liquid ink can gel, e.g., the viscosity of the liquid ink can change significantly from a liquid-like ink to a gel-like ink.

The gelled ink can resist against liquid dispersion, allowing the formation of a high resolution image on the liquid substrate. The printing process can be performed using an automated printer having a movable printer head, such as an ink jet printer head loaded with a liquid ink. The liquid ink can include a color agent.

In some embodiments, the present invention discloses liquid ink mixtures having thermogelling characteristics, and methods to print on liquid substrates using the liquid ink mixtures. The liquid ink mixtures can include an aqueous phase change ink, which can contain a selected concentration of a thermogelling components, which can cause the ink to gel when its temperature is increased above or decreased below its thermo-inversion point. The ink may be jetted directly onto a heated liquid. The thermo-inversion point can be above the ambient temperature, such as the temperature of a hot beverage, e.g., between 50 and 100 C. The thermo-inversion point can be below the ambient temperature, such as the temperature of a cold or cool beverage, e.g., between 20 and 0 C.

The phase change inks can exist in the liquid phase in an ink jet printing device. In operation, droplets of liquid ink can be ejected from the printing device. When the ink droplets contact the surface of the liquid medium, they can quickly solidify, e.g., converting to a gel state, to form a pattern of solidified, e.g., gelled, ink dots.

In some embodiments, the gelling action can occur quickly, e.g., in less than 1 second, such as less than 500 msec, less than 200 msec, less than 100 msec, or less than 50 msec. The ink droplets can have a small dimension, such as less than 100 microns, less than 75 microns, less than 50 micron, or less than 25 microns. The small dimension of the ink droplets can provide high resolution images on the liquid substrate, together with low dispersion due to the fast gelling time caused by the small sizes of the ink droplets.

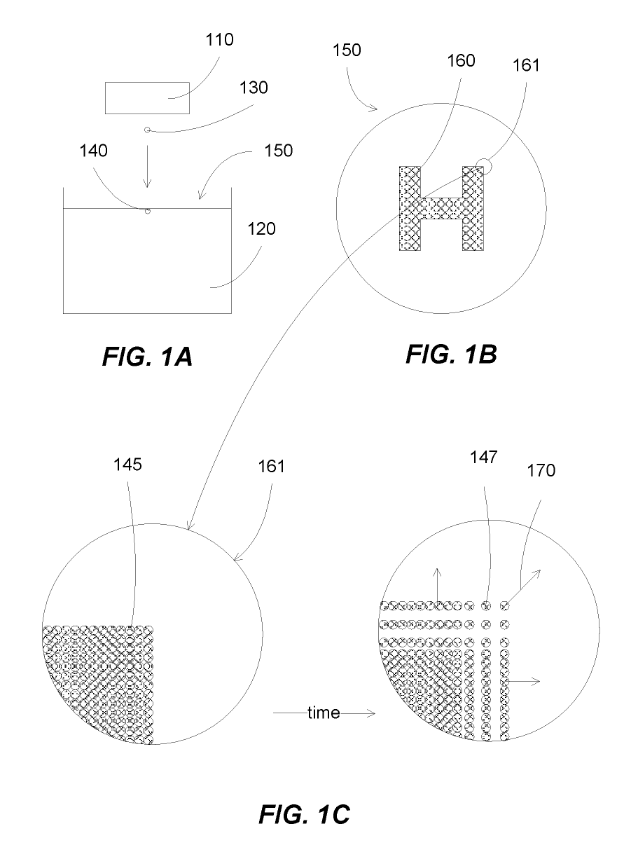

FIGS. 1A-1C illustrate a printing process using a liquid ink on a liquid substrate according to some embodiments. In FIGS. 1A, an ink jet print head 110 can jet liquid ink droplets 130 on a liquid substrate 120. The temperature of the liquid substrate can be different than a temperature of the liquid ink. The temperature of the liquid substrate can be configured so that the liquid ink droplet 130 can gel to form gel droplets 140. The gelling process can include a solidification process, converting the liquid ink droplets into solid, e.g., non-liquid, droplets. The gelling process can include a phase change process, converting the liquid ink droplets into non-liquid droplets, e.g., changing the ink droplets from a liquid phase to a non-liquid phase such as a solid, jelly-like material.

An image can be processed and sent to the ink jet print head. The ink jet print head can then print the image on the surface 150 of the liquid substrate 120. FIG. 1B shows an example of a printed image 160 on the liquid surface 150. The image can include a collection of gel droplets 145, placing adjacent each other. Since the droplets are gel droplets, there can be minimal or no diffusion of the droplets, e.g., there is no enlargement of the droplets 145, or the droplet size can remain constant. However, with time, the border gel droplets 147 can migrate, diffusing outward 170, as shown in FIG. 1C for a portion 161 of the image 160. The diffusion 170 can disperse the border droplets, causing distortion of the image, especially at the borders, e.g., edges of the images. The diffusion can be space and time related, e.g., the border droplets can migrate outward first before the inner droplets can move.

In some embodiments, the present invention discloses methods and systems for printing aqueous inks on liquid substances with reduced image degradation. A barrier can be formed at edges or borders of a printed image, e.g., at non-printed locations adjacent to printed locations. The barrier can confine the image in place, preventing the ink at the edges or borders from diffusing outward.

An aqueous or liquid inks can be used to print images on a liquid substrate, e.g., on a surface of a liquid contained in a container. The aqueous or liquid inks can include phase change inks, which can contain containing liquid soluble compounds that exhibit thermo-inversion properties, e.g., compounds whose liquid solubility decreases as the solution temperature changes. Thus, when droplet ink solutions of these compounds are heated or cooled to their thermo-inversion points, they exhibit thermogelling properties in which these compounds undergo a phase transition to turn the ink droplets into discrete, stable gels, e.g., ink gels.

An image can be formed, e.g., printed, on a liquid medium, using phase change inks that gel instantly on contact with a different temperature liquid substrate, e.g., a liquid medium having a higher or lower temperature than that of the phase change liquid ink. The inks can be gelled instantly, e.g., turning into jelly-like droplets, which can keep the sizes and shapes to form high resolution images that do not become blurred due to ink diffusion.

In some embodiments, the present invention discloses methods and systems to minimize the diffusion of the printed images, such as limiting the movements of the jelly-like droplets that form the edges of the images on or in the liquid medium. The ink droplets at in interior portion of the image can have neighbor droplets at all surrounding sites, which can confine the movements of the ink droplets.

In contrast, the ink droplets at edges or borders of the images can have neighbor droplets at one or more adjacent sides, e.g., not completely surrounded by neighbor droplets, and can face the liquid medium at least one side. Thus the ink droplets at the edges or borders of the images are not constrained at the sides facing the liquid medium, and therefore can diffuse toward the liquid medium, e.g., move in a random motion due to thermal or liquid agitation, which can result in distortions of the images.

In some embodiments, barriers can be formed at the edges of borders of a printed image. The barriers can block movements of the ink droplets, e.g., the ink droplets at the edges or at the borders can now be confined in all directions. For example, a barrier can be formed by printing around the image. The barrier formation can include printing in exterior and interior edges and borders of the image.

In some embodiments, the present invention discloses a method for printing an image on a liquid medium having reduced edge distortion. The method can include printing the image on the liquid medium, together with forming a barrier around the image. The barrier is configured to confine the image.

In some embodiments, the barrier can include ink droplets, e.g., the barrier can be printed using the same print head and at a same time as the image. For example, the image can be printed lines by lines, e.g., the print head can move across the liquid medium, and dispense ink droplets at locations requiring inks. The print head then can advance in a direction perpendicular to the across movement, and then repeat the action of moving across the liquid medium and dispensing ink droplets. At edges or borders of the image, the print head can dispense barrier droplets, which can act as barrier against movements of the image droplets. The barrier droplets can include printed gel droplets, e.g., liquid inks that gel at the edges or border of the image. The barrier droplets can have a clear color, or a color similar to the liquid medium, and thus do not interfere with the image presentation.

In some embodiments, the barrier can be formed by being printed interspersed with the printing of the image. For example, a barrier portion can be printed, followed by a line of image, and then another barrier portion at the end of the image line. The process can be repeated, e.g., the image is printed lines by lines, with each line being printed having barrier droplets capping the image droplets.

In some embodiments, the present invention discloses methods and systems to reduce edge distortion of image printed on liquid surface, by printing at least a portion of a border, interior border or exterior border, around the image.

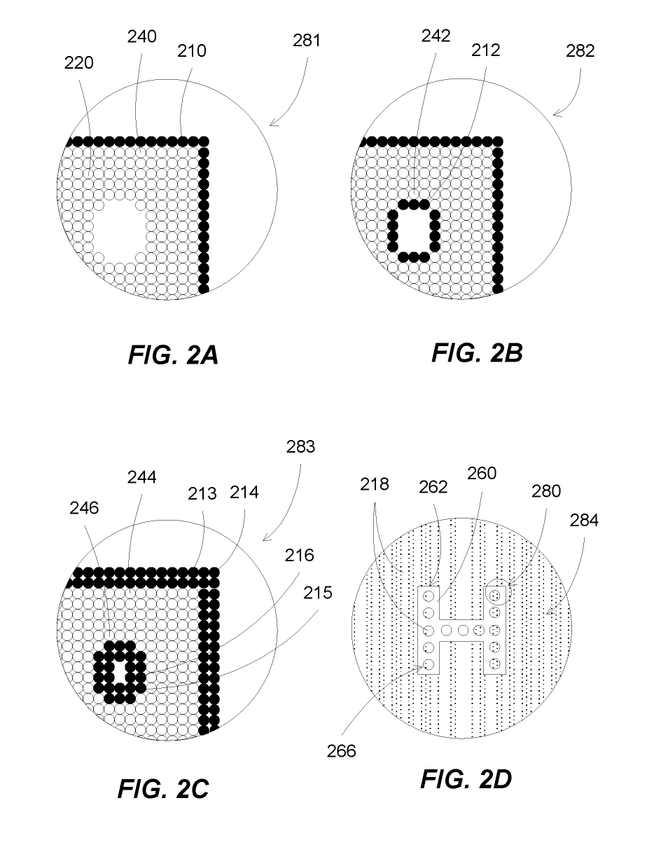

FIGS. 2A-2D illustrate border printing processes according to some embodiments. An ink jet print head can print an image 260 on the surface of the liquid substrate 264. The image can include a collection of gel droplets 220, placing adjacent each other. There can be interior droplets, such as droplet 220. There can be droplets at external borders 262, such as droplet 240, which faces the liquid medium from an external border 262 or edge of the image. There can be droplets at internal borders 266, such as droplet 242, which faces the liquid medium from an internal edge 266 or border of the image.

In some embodiments, the method can include printing an image and at least a portion of a border around the image on a liquid. The method can print an image 260 on a liquid medium 264. A corner 280 of the image 260 can be used to show the gel droplets, e.g., the ink drops that gel when contacting the liquid medium. In FIG. 2A, a corner 281 can show a portion of the image that can include droplets 220 and 240, with the droplet 220 forming an interior portion of the image, and droplet 240 forming an external border of the image. The method can print a portion of a border adjacent to the external border, e.g., printing droplets 210 adjacent to droplet 240. As shown, the printing process can form external droplets 210 all along the droplets 240 of the external border or edge. In some embodiments, there can be some missing portion of the external border, e.g., there can be some droplets at the external border that do not have external droplets.

In FIG. 2B, a corner 282 can show a portion of the image that can include interior droplet 220 and internal droplet 242, e.g., droplet 242 can form an internal border of the image. The method can include printing a portion of a border adjacent to the internal border, e.g., printing droplets 212 adjacent to droplet 242. As shown, the printing process can form internal droplets 212 all along the droplets 242 of the internal border or edge. In some embodiments, there can be some missing portion of the internal border, e.g., there can be some droplets at the internal border that do not have internal droplets.

There can be one or more layers of droplets surrounding the external or internal borders. As shown, there can be one layer of droplets, e.g., the droplets form one layer of droplets at the outside of the external border or at the inside of the internal border.

FIG. 2C shows a corner 283 showing 2 layers of droplets at external and internal borders of the image. The droplet 244 at an external border can have external droplet 213 adjacent to the droplet 244, together with external droplet 214 adjacent to the droplet 213. The droplet 246 at an internal border can have internal droplet 215 adjacent to the droplet 246, together with internal droplet 216 adjacent to the droplet 215.

In FIG. 2D, the surface of the liquid medium 284 can be printed, either with the image or with the border elements, such as droplets 218. The printed image 260 can have external borders 262 and internal borders 266, and the liquid areas within these borders can be printed, e.g., with droplets 218.

In some embodiments, the image can be processed to add the border elements, e.g., the eternal and internal droplets, before printing. For example, the image can be processed so that the non-printing areas, e.g., the portion of the printing canvas (the liquid surface) that does not have the image, can become part of the image to be printed. In other words, the image to be printed can be processed to become a new image that contains border elements, e.g., an image that is larger than the original image.

For example, the new image can cover all area of the liquid surface. Alternatively, a thickness for the border elements can be determined, and the new image can include the original image, together with the border elements having the thickness. The border elements can include external borders, a portion of the external borders, internal borders, a portion of the internal borders, or a complete border surrounding the image.

In some embodiments, the method can include forming a composite image, which can include the image to be printed and at least a portion of a border before printing the composite image. For example, an image can be a solid circle. A border of the image can be a ring surrounding the solid circle. A composite image can include the solid circle and at least a portion of the ring surrounding the solid circle. The image can be a donut shape. An external border of the image can be a ring surrounding the outside of the donut shape. An internal border of the image can be a ring surrounding the inside of the donut shape. A composite image can include the donut shape and at least a portion of the outside ring and/or the inside ring.

The composite image can be printed by an ink jet printer head, using a line-by-line process. For example, a first line can be printed, including left border elements, then the image elements, and tight image elements. The printing can continue until the composite image is completely printed.

In some embodiments, the border, or at least a portion of the border, can be printed interspersed with the image. For example, a portion of the border can be printed, follow by a portion of the image, and then another portion of the border. The border elements and the image elements can be interspersed in any order, in order to print the composite image.

In some embodiments, the border elements can be printed with a selected color. For example, the border elements can be printed with a clear color, e.g., using transparent ink droplets, so that the color of the printed border elements can be the color of the background, e.g., the color of the canvas or the color of the liquid medium. The border elements can be printed with a color of the liquid medium, e.g., the color of the liquid portion adjacent to the border elements. If the liquid medium has a uniform color, then the border elements can be printed using that uniform color. If the liquid medium has different colors at different areas, then the border elements can be printed using the color of the area near the border elements. The border elements can be printed with a color to emphasize or de-emphasize the image. The border elements can be printed with a light color, a contrast color, a phase out color, or a gradient color.

In some embodiments, a color of the border elements can be selected before printing the border elements, or before forming a composite image including the original image and the border elements. For example, a color of the liquid medium can be determined, and the border elements can be printed using the liquid medium color, such as a composite image can be formed using the original image and the border elements having the liquid medium color, and then the composite image can be printed on the liquid.

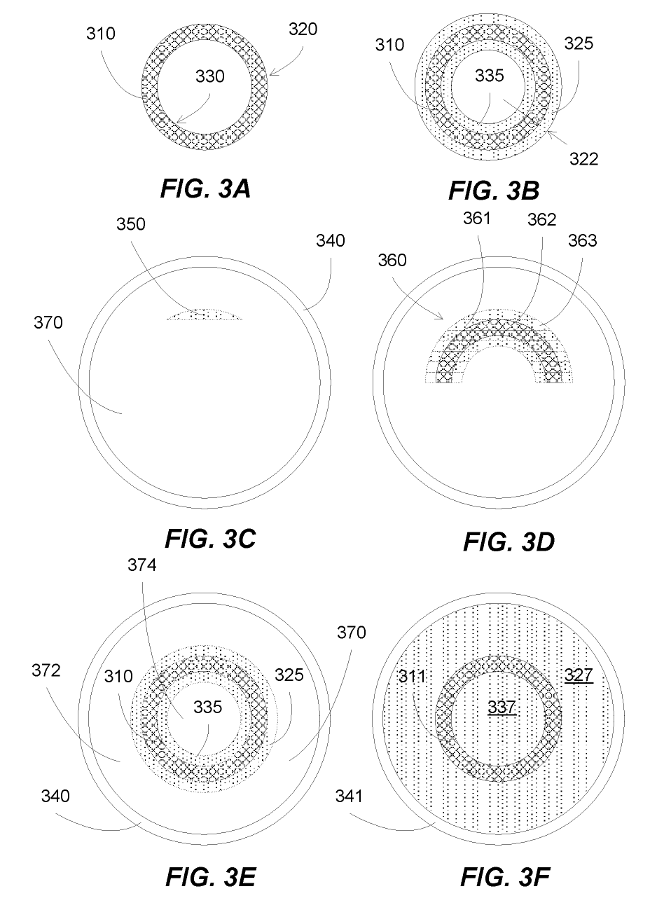

FIGS. 3A-3F illustrate a process for printing an image on a liquid medium according to some embodiments. In FIG. 3A, an image 310 can be prepared. For example, an image can be sent to a printer from a data processing system, such as a computer or a mobile phone. The image 310 can have borders, such as external borders 320 and internal borders 330. The external borders 320 can be borders or edges of the image that a line can be projecting outward without contacting the image. The internal borders 330 can be borders or edges of the image that there is no line that can be projecting outward without contacting the image.

In FIG. 3B, border elements, such as external border elements 325 and internal border elements 335, can be added to the image 310 to form a composite image. The border elements can have a thickness, for example, the external border element 325 can have a thickness 322. In some embodiments, a thickness can be determined, and border elements having the determined thickness can be added to the image.

As shown, the border elements can have a thickness, e.g., there can be some areas of liquid medium surface that are not covered by the border elements. For example, the areas 372 and 374 of the liquid medium 370 is not printed, e.g., not covered by the border elements. The external border elements have a thickness that is smaller than the largest distance from the image to the edge of the liquid container 340, thus there can be some external areas 372 of the image are not printed on the liquid. The internal border elements have a thickness that is smaller than the largest distance across the interior of the image, thus there can be some internal areas 374 of the image are not printed on the liquid.

In some embodiments, the border elements can completely cover the liquid medium surface, e.g., the border elements can be present on all areas of the liquid medium surface that are not covered by the image.

In some embodiments, the border elements can have colors selected to match the image on the liquid medium. The border elements can have one or more colors, e.g., different portions of the border elements can have different colors. The border elements can have a color of clear, e.g., transparent. The border elements can have the colors of the liquid medium. The border elements can have a color to emphasize or de-emphasize the image. The border elements can have a light color, a contrast color, a phase out color to the liquid color, or a gradient color from the image to the liquid medium.

The image 310 and the border elements 325 and 335 can form a composite image, which can be sent to a printer for printing on a liquid medium. A printer head can be positioned on a container 340 having a liquid 370. The printer head can move line-by-line, e.g., rastering on the surface of the liquid.

FIG. 3C shows a first rastered line 350 that the printer head can print on the liquid by passing through the liquid. The first rastered line can include the border elements, e.g., the outermost portion of the external border elements 325.

FIG. 3D shows multiple rastered lines that the printer head forms. In a typical rastered line 360, a portion 361 of the external border elements 325 can be printed, followed by a portion 362 of the image, followed by a portion 363 of the external border elements 325. At other rastered lines, portions of external border elements 325, portions of internal border elements 335, and portions of the image 310 can be printed interspersed, e.g., one followed the other.

FIG. 3E shows a printed image, including the image 310 and the border elements 325 and 335 in a liquid 370 contained in a container 340. As shown, there are some portions 372 and 374 of the liquid surface that are not printed, e.g., having no ink droplets.

FIG. 3F shows another configuration of a printed image, including the image 311 and the border elements 327 and 337 in a liquid contained in a container 341. The liquid surface can be completely printed, for example, with the border elements 327 and 337 covering the whole surface area.

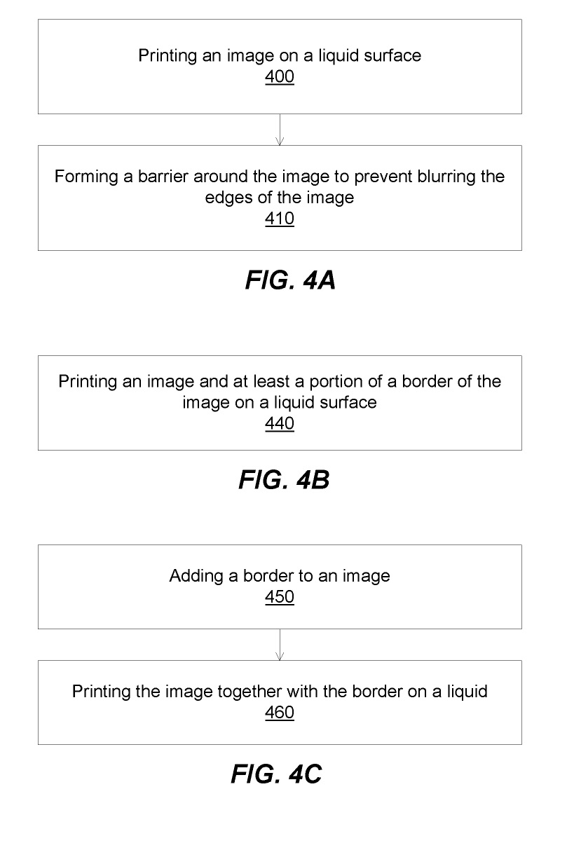

FIGS. 4A-4C illustrate flow charts for liquid printing according to some embodiments. In FIG. 4A, operation 400 prints an image on a liquid surface. Operation 410 forms a barrier around the image to prevent blurring the edges of the image.

In FIG. 4B, operation 440 prints an image and at least a portion of a border of the image on a liquid surface. In FIG. 4C, operation 450 adds a border to an image. Operation 460 prints the image together with the border on a liquid.

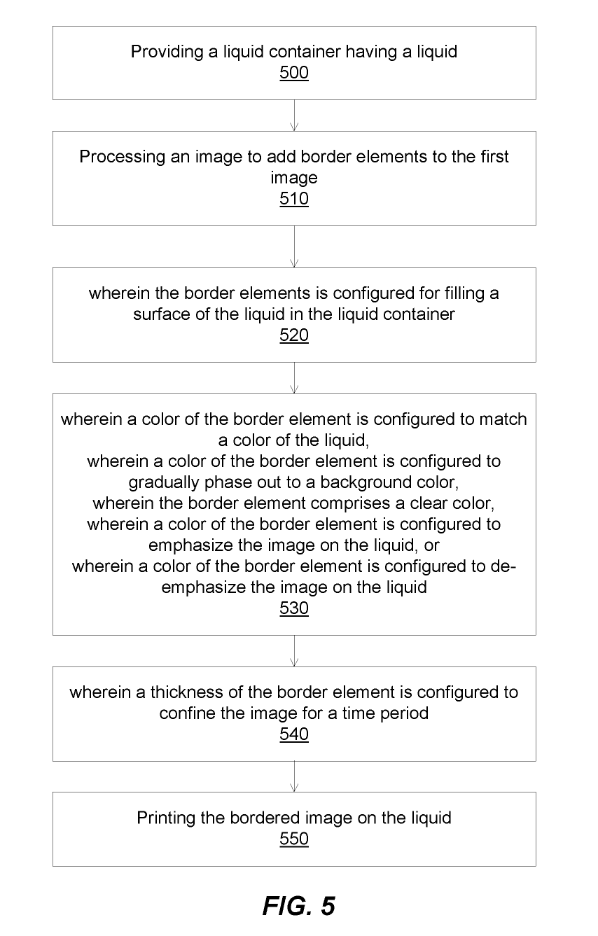

FIG. 5 illustrates a flow chart for liquid printing according to some embodiments. Operation 500 provides a liquid container having a liquid. Operation 510 processes an image to add border elements to the first image. In operation 520, the border elements is configured for filling a surface of the liquid in the liquid container. In operation 530, a color of the border element is configured to match a color of the liquid, a color of the border element is configured to gradually phase out to a background color, the border element comprises a clear color, a color of the border element is configured to emphasize the image on the liquid, or a color of the border element is configured to de-emphasize the image on the liquid. In operation 540, a thickness of the border element is configured to confine the image for a time period. Operation 550 prints the bordered image on the liquid.

In some embodiments, the present invention discloses printer heads for printing on liquid substrates. A printer head can have at least one ink head portion, with the at least one ink head portion configured to accept a liquid phase change ink having a clear color, e.g., a transparent color. For example, a printer head can have one row of nozzles, with the row configured to be coupled to an ink reservoir. The row of nozzles can be configured to accept a clear color ink. The printer head can be used to print a clear droplets, such as transparent droplets, on a liquid substrate.

A printer head can have 2 rows of nozzles, with each row configured to be coupled to an ink reservoir. One row of nozzles can be configured to accept a clear color ink. The other row can be configured to accept a color ink, such as black ink or other color inks.

A printer head can have nozzles partitioned into two or more portions, such as 4 portions of nozzles, with different portions configured to be coupled to different ink reservoirs. One portion of nozzles can be configured to accept a clear color ink. The other portions can be configured to accept different color inks, such as cyan, magenta, and yellow for 4 portion printer heads, or cyan, magenta, yellow, and black for 5 portion printer heads.

In some embodiments, a printer head can include a 2 portion printer head, with one portion configured to be coupled to a clear color ink reservoir. The other portion can be configured to be coupled to a black color ink reservoir. Other color, instead of black, can be used.

In some embodiments, a printer head can include a 4 portion printer head, with one portion configured to be coupled to a clear color ink reservoir. The other portions can be configured to be coupled to cyan, magenta, and yellow color ink reservoirs. Other colors, instead of cyan, magenta, and yellow, can be used.

In some embodiments, a printer head can include a 5 portion printer head, with one portion configured to be coupled to a clear color ink reservoir. The other portions can be configured to be coupled to cyan, magenta, yellow, and black color ink reservoirs. Other colors, instead of cyan, magenta, yellow, and black, can be used.

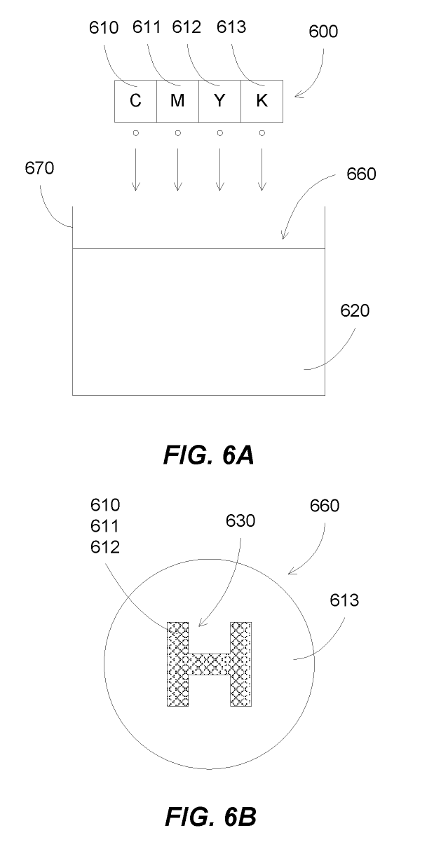

FIGS. 6A-6B illustrate a print head having a clear color printing assembly according to some embodiments. A print head 600 can have multiple nozzles configured to deliver, such as jetting droplets due to thermal energy or due to piezo action. The nozzles can be coupled to a liquid ink delivery assembly, with the color of the liquid ink being clear, e.g., transparent. The nozzles can be partitioned into 2 or more portions, with different portions coupled to different liquid ink delivery assemblies, with the color of one liquid ink in at least one liquid delivery of the liquid deliveries being clear, e.g., transparent.

As shown, the print head 600 is partitioned into 4 portions, with one portion 610 connected to a color ink of cyan, one portion 611 connected to a color ink of magenta, one portion 612 connected to a color ink of yellow, and one portion 613 connected to a color ink of clear, e.g., the key color is clear. The three color inks of cyan, magenta, and yellow can be used to print an image 630 on a surface 660 of a liquid 620 contained in a liquid container 670. The color ink of clear can be used to print border elements, e.g., areas outside the external borders or external edges and areas inside the internal borders or internal edges of the image.

In some embodiments, the present invention discloses printers, and methods to use the printers, to print liquid inks on liquid surfaces. The printers can include ink jet printers, which can deposit droplets of liquid on a substrate.

Ink jet printers can include an ink supply for supplying inks to a nozzle head, at which the ink drops are ejected. Ink drop ejection can be controlled by an actuator, such as a piezo actuator or a thermal actuator. A piezoelectric actuator can include a piezoelectric material, which bends in response to an applied voltage. The bending of the piezoelectric layer pressurizes the ink to leave the nozzle head. A thermal actuator can include a resistor, which can be heated when a voltage or current is applied. The thermal energy generated by the heated resistor can pressurize the ink to leave the nozzle head.

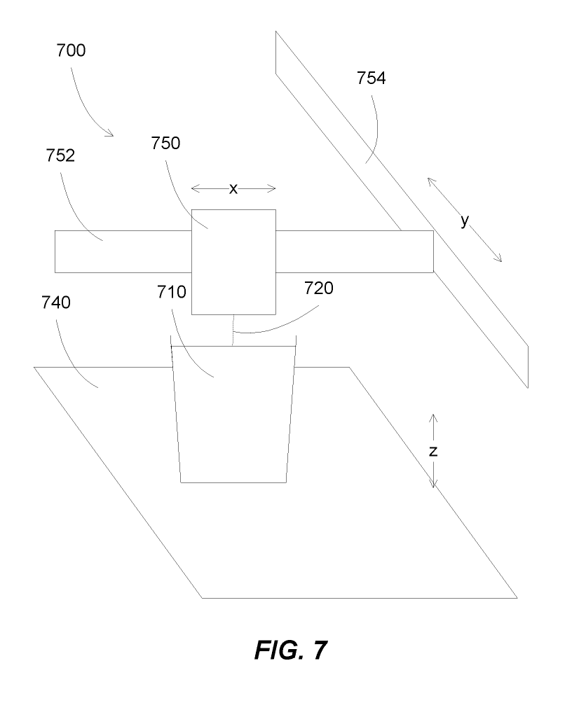

FIG. 7 illustrates a schematic of a printer for printing on a liquid according to some embodiments. The printer 700 can include a platform 740 for supporting a liquid container 710. The platform 740 can move in a z direction, for example, up and down, to bring the liquid container 710 closer to a printer head 750. In some embodiments, the platform can move so that the top surface of the liquid container is less than 10 mm or less than 5 mm from a bottom surface of the printer head 750. The printer head 750 can move in lateral directions, such as x and y directions. For example, a moving mechanism 752 can be configured to move the printer head 750 in the x direction. A moving mechanism 754 can be configured to move the printer head, e.g., through moving the mechanism 752, in the y direction. Other moving mechanisms can be used, such as a x-y table configured to move the printer head. In addition, the platform can be stationary, with the printer head moves in the z direction. A controller can be included to move the printer head according to a pattern for printing on the liquid surface. Other components can be included, such as ink reservoirs for different color inks. The printer can be loaded with thermogelling phase change liquid ink.

In operation, printer reservoirs containing liquid inks are connected to the printer head in the printer. A liquid container can be placed on the platform. The liquid can be at a temperature suitable for the printer ink, e.g., higher than the gelling temperature of the printer ink. If the temperature of the liquid is not suitable, the printer reservoirs can be replaced with other printer reservoirs that are suitable for the liquid on the platform. The temperature of the printer reservoirs can be controlled, so that it is lower than the temperature of the liquid.

The platform can move relative to the printer head so that the printer head is at a set distance from the liquid surface. The printer head can move according to a pattern to print on the liquid surface. Ink droplets 720 can be jetted to the liquid surface, and gelled instantly upon contacting the liquid.

A liquid container can be loaded to a platform, wherein the liquid container comprises a liquid. A height of the platform can be adjusted. A printer head can move to print a pattern on the liquid surface with a liquid ink, wherein the liquid ink gels when contacting the liquid, and wherein the pattern include an image and border elements bordering the image.

A liquid drink can be supplied on a platform of a printer system. An edible liquid ink can be printed on the liquid drink, wherein the liquid ink can include a thermogelling component, and a printed image can include border elements.

In some embodiments, the present invention discloses a printing process for printing an image using liquid phase change inks on liquid media. The phase change inks, in the form of ink droplets, can form gel droplets when contacting the liquid media. A liquid ink can be used. The liquid ink can have a thermo-inversion gelling property, e.g., the liquid ink can change phase, such as converting to a gel state from a liquid state, when subjected to a different temperature ambient, such as when contacting a liquid medium having a hotter or colder temperature. For example, a thermogelling component can be mixed with a solvent, such as water to form a liquid ink solution. Color agents can be added to the liquid ink solution to form a liquid ink having a thermo-inversion gelling property. The concentration of the thermogelling component can be based on the temperature of liquid substrate that the liquid ink will be printed upon. For example, the concentration of the thermogelling component in the liquid ink can be a concentration that the liquid ink can quickly gel upon contacting the liquid substrate, which can have a temperature different than the temperature of the liquid ink.

The liquid ink can be supplied in droplet forms to the liquid substrate. Since the concentration thermogelling component in the liquid ink is at concentration that allowing the liquid ink to gel at the temperature of the liquid substrate, when the liquid droplets contact the liquid substrate, the liquid droplets can form gel droplets.

In some embodiments, the phase change liquid ink can be used to print images on a liquid substrate. A liquid can be provided at a first temperature. The liquid can be contained in a container. The liquid can be a liquid drink, such as coffee, tea, or beer. The liquid can be heated or cooled to the first temperature. The liquid can be prepared using a hot liquid at a temperature higher than the first temperature, such as using hotter water for brewing a hot coffee drink or a hot tea drink. The liquid can be prepared using a heater system for heating the liquid. The liquid can be prepared using a cooling system for cooling the liquid, such as by refrigerating the liquid or by adding ice to the liquid.

A phase change liquid ink can be used to print on the liquid surface. The liquid ink can be an edible ink for used with a liquid drink. The liquid ink can be a thermogelling aqueous phase change ink at a critical concentration so that the liquid ink can turn into gel droplets upon contacting the liquid. For example, the liquid ink can have a thermo-inversion gelling property at a second temperature below the first temperature, thus when the liquid ink contacts the hot liquid, the liquid ink is subjected to an ambient having higher temperature than the gelling temperature of the liquid ink, and therefore converting to a gel state, e.g., forming gel droplets. The liquid ink can have a thermo-inversion gelling property at a second temperature above the first temperature, thus when the liquid ink contacts the cold liquid, the liquid ink is subjected to an ambient having lower temperature than the gelling temperature of the liquid ink, and therefore converting to a gel state, e.g., forming gel droplets.

In some embodiments, the present invention discloses edible inks having a thermogelling component, e.g., edible thermogelling aqueous phase change ink. The thermogelling aqueous phase change ink can include a nonionic surfactant, as disclosed in U.S. Pat. No. 5,462,591, which is incorporated by reference in its entirety, such as tetra-functional block copolymer surfactant terminating in primary hydroxyl groups such as ethylene oxide and propylene oxide, or an alkoxylated diamine. The nonionic surfactant can include a polyoxamine, having an alkyldiamine center (ethylene diamine, N—CH₂—CH₂—N), a hydrophobic core of y propylene oxide units, and hydrophilic end of x ethylene oxide units.

Numerous concentrations and combinations of these thermogelling components may be employed. A variety of other components that exhibit thermogelling properties may be used in ink compositions, such as homopolymers, copolymers, nonpolymeric or nonionic surfactants, naturally occurring polymers and their derivatives.

In some embodiments, the liquid ink drop may be jetted onto a liquid substrate that is warmer or cooler than the thermo-inversion point of the ink composition. Contact with the warm or cool liquid substrate can instantly gel the ink drop. For example, a hyperthermogelling ink composition can be formulated to have a thermo-inversion point at a temperature below 30, below 40, or below 50 C. Such an ink composition could be jetted as a liquid at room temperature and would gel instantly after contacting a hot drink, such as a hot coffee or a hot tea drink, which has a temperature higher than the thermo-inversion point. Similarly, a thermogelling ink composition can be formulated to have a thermo-inversion point at a temperature below 0, below 5, or below 10 C. Such an ink composition could be jetted as a liquid at room temperature and would gel instantly after contacting a cold drink, such as a cold beer or cold soft drink, which has a temperature lower than the thermo-inversion point.

Alternatively, a thermogelling ink composition can be formulated to have a thermo-inversion point at room temperature, e.g. between 15 and 30 C. The ink composition can be maintained as a liquid at a temperature below room temperature, and would gel instantly after contacting a liquid at room temperature.

Alternatively, a thermogelling ink composition can be formulated to have a thermo-inversion point below room temperature, such as between 0 and 10 C. The ink composition can be maintained as a liquid at a temperature below this thermo-inversion temperature, and would gel instantly after contacting a cold liquid at temperatures between 0 and 10 C.

In some embodiments, a temperature of a liquid substrate can be determined. A liquid ink having a concentration of a thermogelling component can be prepared, wherein the concentration is configured so that the liquid ink is gelled when the liquid ink contacts the liquid substrate. For example, the concentration of the liquid ink can be configured so that the liquid ink is gelled at a temperature below or above the temperature of the liquid substrate. The liquid ink can be used to print on the liquid substrate.

In some embodiments, a liquid ink can be prepared, wherein the liquid ink comprises thermo-inversion gelling property at a first temperature. A liquid substrate can be heated or cooled to a temperature above or below the first temperature. The liquid ink can be used to print on the liquid substrate, so that the liquid ink changes phase to gel state when contacting the liquid substrate.

In some embodiments, the present invention discloses a system for printing on a liquid surface of a liquid medium. The system can include a print head, wherein the print head is configured to accept a key color of clear. The print head can be configured to accept one or more colors of cyan, magenta, yellow, and black. The system can also include a platform configured to support a container having the liquid medium, an x-y mechanism, wherein the x-y mechanism is configured to move the print head in x and y directions with respect to the platform, one or more reservoirs coupled to the print head, wherein the reservoirs are configured to supply edible thermogelling phase change liquid inks to the print head.

What is claimed is:

1. A method comprising
printing an image on a liquid;
forming a barrier around the image, wherein the barrier is configured to confine the image.

2. A method as in claim 1
wherein the barrier comprises printed gel droplets.

3. A method as in claim 1
wherein forming the barrier is performed interspersed with the image printing process.

4. A method as in claim 1
wherein forming the barrier comprises printing around the image.

5. A method comprising
printing an image and at least a portion of a border around the image on a liquid.

6. A method as in claim 5 further comprising
processing the image to add border elements before printing.

7. A method as in claim 5
wherein printing an image and at least a portion of a border around the image comprises
forming a composite image comprising the image and the at least a portion of a border;
printing the composite image.

8. A method as in claim 5
wherein the at least a portion of a border is printed interspersed with the image printing process.

9. A method as in claim 5
wherein the at least a portion of a border is printed with a clear color.

10. A method as in claim 5 further comprising
determining a color for the at least a portion of a border;
printing the at least a portion of a border using the color.

11. A method as in claim 5 further comprising
determining a color of the liquid;
printing the at least a portion of a border using the color.

12. A method as in claim 5
wherein the at least a portion of a border is printed with a gradient color from the image to the liquid.

13. A method as in claim 5
wherein a color of the at least a portion of a border is selected to provide emphasis to the image.

14. A method as in claim 5
wherein a color of the at least a portion of a border is selected to de-emphasize the image.

15. A method as in claim 5 further comprising
determining a thickness for the at least a portion of a border around the image.

16. A method as in claim 5
wherein printing at least a portion of a border around the image comprises printing an external border or an internal border of the image.

17. A method as in claim 5
wherein printing at least a portion of a border around the image comprises printing all areas of the liquid surface not covered by the image.

18. A system for printing on a liquid surface of a liquid medium, the system comprising
a print head, wherein the print head is configured to accept a key color of clear.

19. A system as in claim 18
wherein the print head is configured to accept other colors of cyan, magenta and yellow.

20. A system as in claim 18 further comprising
a platform configured to support a container having the liquid medium;
an x-y mechanism, wherein the x-y mechanism is configured to move the print head in x and y directions with respect to the platform;
one or more reservoirs coupled to the print head, wherein the reservoirs are configured to supply edible thermogelling phase change liquid inks to the print head.
